(19) United States
(12) Patent Application Publication
(10) Pub. No.: US 2021/0112091 A1
(43) Pub. Date: Apr. 15, 2021

(54) DENIAL-OF-SERVICE DETECTION AND MITIGATION SOLUTION

(71) Applicant: Charter Communications Operating, LLC, St. Louis, MO (US)

(72) Inventor: Richard A. COMPTON, Highlands Ranch, CO (US)

(21) Appl. No.: 16/599,117

(22) Filed: Oct. 10, 2019

(51) Int. Cl. H04L 29/06

(52) U.S. Cl. CPC H04L 63/1458; H04L 63/1433; H04L 63/1425; H04L 63/1416

(57) ABSTRACT

A system, central controller, and method for mitigating a distributed denial-of-service (DDoS) attack in a networked computing system. One or more records including meta-data about network traffic are received from one or more network devices and anomalous network traffic is identified. A source address of the anomalous network traffic is determined and a mitigation action is initiated based on the source address and one or more mitigation rules, wherein a determination of whether the received data packet is part of the DDoS attack is based on one or more detection rules.

### FIELD OF THE INVENTION

The present invention relates generally to the electrical, electronic and computer arts, and, more particularly, to the detection and mitigation of denial-of-service attacks.

### BACKGROUND OF THE INVENTION

In the context of computing, a denial-of-service (DoS) attack is an attempt to make a machine or network resource unavailable to its intended users. A distributed denial-of-service (DDoS) attack is an attack in which multiple compromised computer systems attack a target resource, such as a server, router, firewall, website, or other network resource, and cause a denial of service for users of the targeted resource. A flood of incoming messages, connection requests, malformed packets, and the like creates a stream of “bogus” traffic which, when transmitted to the target system, forces it to slow down or even crash and shut down. Since a server or other network resource can only process a limited number of requests at any given time, if an attacker overloads the target resource with requests, it is unable to process the requests of its legitimate users, thereby resulting in a “denial of service” because the legitimate users are prevented from accessing that resource.

Two common types of DDoS attacks are bandwidth attacks and application attacks. Bandwidth attacks are DDoS attacks which consume resources, such as network bandwidth or communication and processing equipment, by overwhelming one or the other (or both) with a high volume of packets. Targeted routers, servers, firewalls, and the like, all of which have limited processing capability, can be rendered unavailable to process valid transactions, and can fail under the load. One common form of bandwidth attack is a packet-flooding attack, in which a large number of seemingly legitimate Transmission Control Protocol (TCP), User Datagram Protocol (UDP), Internet Control Message Protocol (ICMP) and/or other protocol packets are directed to a target destination, thus filling up the available bandwidth to the target and preventing valid connections from being established. To make detection even more difficult, such attacks might also spoof the source address; that is, misrepresent the Internet Protocol (IP) source address that supposedly generated the request to prevent identification. In some instances, the address of the attack victim is maliciously utilized by the attacker, or spoofed. Application attacks, on the other hand, are DDoS attacks that use the expected behavior of protocols, such as, for example, TCP and Hypertext Transfer Protocol (HTTP), to an attacker's advantage by tying up computational resources and preventing them from processing transactions or requests. HTTP half-open and HTTP error attacks are common examples of application attacks.

Since DDoS attacks are by definition distributed, it can be very difficult to mitigate attack traffic when the attacking source IP addresses are so widespread. Furthermore, a growing trend among DDoS attackers is to use sophisticated spoofing techniques and essential protocols (rather than nonessential protocols that can be blocked) to make DDoS attacks even more stealthy and disruptive. These attacks, which use legitimate application protocols and services, are very difficult to identify and defeat; employing broad packet-filtering or rate-limiting measures simply completes the attacker's desired objective by shutting down the system, causing denial of service to legitimate users.

In one particular type of attack, a domain name system (DNS) query may be submitted by an attacker to an open DNS server. The attacker utilizes (or spoofs) the IP address of the victim in the DNS query. Responses from the DNS server to the DNS query typically include a large number of packets due to the amount of data in a typical query response. Thus, the DDoS attack effectively amplifies the traffic generated by the attacker. Since the packets of the query response are directed to the victim due to the spoofed IP address, the computing and network resources of the attack victim can be overwhelmed, leading to a denial of service for users of these resources.

### SUMMARY OF THE INVENTION

Principles of the invention provide a detection and mitigation solution for a distributed denial-of-service attack. In one aspect, an exemplary method includes operations of receiving one or more records including meta-data about network traffic from one or more network devices; identifying anomalous network traffic; determining a source address of the anomalous network traffic; and initiating a mitigation action based on the source address and one or more mitigation rules, wherein a determination of whether the received data packet is part of a DDoS attack is based on one or more detection rules.

In one aspect, a system for mitigating a distributed denial-of-service (DDoS) attack in a networked computing system comprises one or more network devices, each network device configured to provide records including meta-data about network traffic; and at least one central controller configured to receive one or more of records including meta-data about network traffic from the one or more network devices, identify anomalous network traffic, determine a source address of the anomalous network traffic, and initiate a mitigation action based on the source address and one or more mitigation rules, wherein a determination of whether the received data packet is part of the DDoS attack is based on one or more detection rules.

In one aspect, a central controller for mitigating a distributed denial-of-service (DDoS) attack in a networked computing system comprises a memory; and at least one processor, coupled to said memory, and operative to perform operations comprising receiving one or more records including meta-data about network traffic from one or more network devices; identifying anomalous network traffic; determining a source address of the anomalous network traffic; and initiating a mitigation action based on the source address and one or more mitigation rules, wherein a determination of whether the received data packet is part of the DDoS attack is based on one or more detection rules.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of an article of manufacture including a machine readable medium that contains one or more programs which when executed implement one or more method steps set forth herein; that is to say, a computer program product including a tangible computer readable recordable storage medium (or multiple such media) with computer usable program code for performing the method steps indicated. Furthermore, one or more embodiments of the invention or elements thereof can be implemented in the form of an apparatus (e.g., a central controller, an intrusion detection system (IDS), an Internet Service Provider (ISP) peering router, data center, DDoS mitigation device, and the like) including a memory and at least one processor that is coupled to the memory and operative to perform, or facilitate performance of, exemplary method steps. Yet further, in another aspect, one or more embodiments of the invention or elements thereof can be implemented in the form of means for carrying out one or more of the method steps described herein; the means can include (i) specialized hardware module(s), (ii) software module(s) stored in a tangible computer-readable recordable storage medium (or multiple such media) and implemented on a hardware processor, or (iii) a combination of (i) and (ii); any of (i)-(iii) implement the specific techniques set forth herein.

Aspects of the present invention can provide substantial beneficial technical effects. For example, one or more embodiments of the invention achieve one or more of:
enhanced accuracy of information regarding the destination of a suspected DDoS attack to provide more targeted DDoS mitigation options;
targeted DDoS detection technique that mitigates attack traffic flow;
targeted DDoS mitigation actions based on at least the source of the detected malicious traffic for alleviating DDoS attacks without adversely impacting the flow of valid traffic in the system; and
implementation of the novel DDoS detection and mitigation techniques can be easily integrated with existing system hardware, thereby providing a more robust DDoS detection and mitigation mechanism without significantly increasing system overhead and complexity.

These and other features and advantages of the present invention will become apparent from the following detailed description of illustrative embodiments thereof, which is to be read in connection with the accompanying drawings.

### BRIEF DESCRIPTION OF THE DRAWINGS

The following drawings are presented by way of example only and without limitation, wherein like reference numerals (when used) indicate corresponding elements throughout the several views, and wherein:

FIG. 1 is a block diagram conceptually depicting the occurrence of a DDoS attack in an exemplary networked computing system.

FIG. 2 is a block diagram depicting at least a portion of an exemplary system for detecting and mitigating DDoS attacks in a networked computing system, according to an embodiment of the invention.

FIG. 3 is a flow diagram depicting a first example method for detecting and mitigating DDoS attacks, according to an embodiment of the invention.

FIG. 4 is a flow diagram depicting a second example method for detecting and mitigating DDoS attacks, according to an embodiment of the invention.

FIG. 5 is a flowchart of an example method for performing a deep inspection of a suspected anomalous packet, in accordance with an example embodiment; and

FIG. 6 is a block diagram of at least a portion of an exemplary system that can be configured to implement at least some aspects of the invention, according to one or more embodiments of the present invention.

It is to be appreciated that elements in the figures are illustrated for simplicity and clarity. Common but well-understood elements that may be useful or necessary in a commercially feasible embodiment may not be shown in order to facilitate a less hindered view of the illustrated embodiments.

### DETAILED DESCRIPTION OF PREFERRED EMBODIMENTS

Principles of the present disclosure will be described herein in the context of apparatus and methods for detecting and mitigating distributed denial-of-service (DDoS) attacks in a networked computing environment. It is to be appreciated, however, that the specific apparatus and/or methods illustratively shown and described herein are to be considered exemplary as opposed to limiting. Moreover, it will become apparent to those skilled in the art given the teachings herein that numerous modifications can be made to the embodiments shown that are within the scope of the appended claims. That is, no limitations with respect to the embodiments shown and described herein are intended or should be inferred.

One or more embodiments provide a method of detecting and mitigating distributed denial-of-service (DDoS) attack network traffic. In one example embodiment, a host computer is running a service that can be used for a DDoS attack, such as an attack using amplification of network traffic (such as DNS, Network Time Protocol (NTP), Chargen, Memcache, and the like). A central controller determines whether a DDoS attack is underway and determines whether to initiate a mitigation action(s) based on NetFlow records obtained, for example, from a network router. In one or more embodiments, a number of intrusion detection systems inspect the incoming network traffic and send alerts to the central controller for use in detecting an attack. The alerts whether malicious network traffic has been detected. The netflow records and alerts may contain only the source address of the network traffic (such as a source IP address), or may contain additional information. The additional information may include, for example, application layer information from the payload of the packet indicating, for example, the type of query that is being requested. The central controller extracts, for example, the source address of the network traffic (from the netflow records, alerts, and/or the network traffic log) that is being targeted by the attack traffic and generates one or more rules to mitigate the attack, for example, to block the attack traffic. For example, if the central controller is aware of the type of query being requested, the central controller can generate a rule that activates a specific type of filter for the specified type of query. The mitigation action(s) specified by the rules are then implemented by, for example, various network devices. Once the central controller no longer detects the attack traffic, the central controller will then instruct the network devices to remove the mitigation action, such as to remove the block of the attack traffic. In one example embodiment, the central controller is integrated into one of the intrusion detection systems.

It should be noted that, generally, while some embodiments use netflow records, any suitable records including meta-data about network traffic can be employed. As used in the specification, netflow records should be understood as one non-limiting exemplary embodiment of records including meta-data about network traffic.

In one example embodiment, traffic flows (as characterized by the netflow records and/or the alerts) are analyzed to identify suspected anomalous network traffic. Suspected anomalous network traffic exhibits, for example, unusual behavior in comparison to normal traffic flows. For example, botnet command and control traffic may be identified as suspected anomalous network traffic due to the volume of traffic, the destination of the traffic, and the like. In one example embodiment, the suspected anomalous network traffic is diverted, for example, to a deep packet inspection device where the suspected anomalous network traffic is subjected to further inspection and a determination of whether the network traffic is anomalous. Using the techniques disclosed herein, only a subset of the overall network traffic is subjected to deep packet inspection and a reduction in required DPI processing capacity can advantageously be attained.

In one example embodiment, a mitigation action(s) is performed if the network traffic is suspected of being anomalous, if network traffic is confirmed to be anomalous (such as following deep packet inspection), and the like. For example, the network traffic can be blocked, rate limited, and the like; a notification regarding the anomalous network traffic can be issued (such as to an administrator, security operations center, and/or customer); and the like. In one example embodiment, the mitigation action is performed if the network traffic is suspected of being anomalous. In one example embodiment, the mitigation action is performed only if the network traffic is confirmed to be anomalous.

If the network traffic is determined not to be anomalous, it is routed to its original destination and information regarding the false positive classification (as anomalous network traffic) is utilized to further refine the classification rules.

If it cannot be confirmed whether the traffic is anomalous, a number of actions may be taken, including rate limiting the traffic, issuing an alert, routing the traffic to its original destination, and the like. Thus, one or more embodiments identify and mitigate anomalous network traffic, such as malicious traffic.

In general, the anomalous network traffic flows are identified in a number of ways. In one example embodiment, an anomalous flow is identified by the behavior of the network traffic. For example, a traffic source, such as a host computer, may be identified as normally exhibiting a certain behavior(s), such as communicating with certain destinations (such as certain IP addresses) using certain communication protocols and certain traffic volumes/patterns (such as a certain number of requests per second). A deviation from the normal behavior may result in the network traffic being suspected of being anomalous. For example, sending atypical volumes of data to destinations outside of a usual geographic area of the host computer transmitting the network traffic may result in the network traffic being suspected of being anomalous. Other types of behavior include, but are not limited to, IP traffic exceeding a specified threshold, IP traffic exceeding a dynamically generated threshold (the dynamic threshold can be defined by observing “normal” traffic patterns), unusual packet sizes, unusual TCP flags (such as an excessive number of SYN packets), connection to an IP address that is not in the Alexa top 1 million addresses, connection to an IP address on an unusual port, connection to an IP address that no known host has ever connected to, connection to an IP address in a country that a given host has never connected to, look up of a domain name that is not in the Alexa top 1 million, look up of a domain name that no known host has ever looked up, and look up of a domain name that is new (such as a domain name that is less than 24 hours old). In some embodiments, supervised machine learning is used to find anomalous flows; KNN (K nearest neighbor) is a non-limiting example of a suitable technique.

In one example embodiment, information regarding network traffic is also obtained from various devices, such as network devices, servers, and the like. For example, netflow records regarding network traffic are obtained from one or more network routers. The netflow records contain, for example, the source IP address/port number, the destination IP address/port number, and the number of bytes transferred for a given traffic flow. Similarly, DNS flow information may be obtained from one or more DNS servers. The network information is ingested and the network flows are classified into normal flows or anomalous flows based on classification rules.

In one example embodiment, the classification rules are based on information from, for example, third-party threat intelligence providers that provide information identifying traffic that is malicious or suspected of being malicious (such as lists of malicious source IP addresses), traffic patterns that are malicious or suspected of being malicious (such as short lived connections to numerous hosts which could be indicative of malicious scanning behavior), and the like.

In one example embodiment, mitigation rules are also developed. For example, mitigation rules for configuring network devices to route the “normal” traffic through to the original destination and to route the “anomalous” traffic to, for example, a Deep Packet Inspection (DPI) appliance, a rate limiting appliance, and the like may be defined. The device that receives the anomalous traffic then, for example, inspects the payload, the traffic rates of the anomalous traffic, and similarly for the diverted traffic. If the inspection confirms that the network traffic is anomalous, mitigation actions (or additional mitigation actions if actions have been performed based solely on the initial classification), such as rate limiting or filtering the anomalous network traffic, are performed.

Other aspects of network information, such as the DNS lookups that a host performs, can also be incorporated into the detection and mitigation technique. While the information for a DNS flow is different than the information of the netflows, it can be used for classifying traffic in a similar manner.

In one example embodiment, the deep packet inspection device performs a deep packet inspection, identifies indicators of compromise (IOC), and determines if the suspicious traffic matches known threat detection signatures. For example, indicators of compromise in the traffic may be searched for, such as a source or destination IP address, a source or destination port, a protocol, a type, size, or contents of the payload, identification of a pattern in the traffic, a match of the pattern with known threat signatures, and the like. A pattern may include, but is not limited to, a combination of two or more of source IP address, destination IP address, source port, destination port, packet size, header metadata, protocol type, domain name, payload contents, file analysis, hash value, etc. In one or more embodiments, this pattern is compared to previously known malware signatures (in the history of the Internet) and a determination is made. The deep packet inspection device can pass or block the network traffic, and can validate an IP address to, for example, reduce false positives when searching for malicious IP addresses.

As described above, in one example embodiment, the mitigation action blocks the anomalous traffic, reroutes the anomalous traffic, and the like. A malicious bot, for example, may be rendered useless by blocking communications with the servers of the botnet. For example, although the bot might still be present on a customer's device, it becomes harmless since it is not able to get commands from its command and control server. In addition, the customer is informed about the bot infection and may take action to remove the malicious bot by running anti-virus software, upgrading the operating system (OS) of the device, and the like.

In one example embodiment, a user, such as a member of a security operations team, the customer of an ISP, and the like, is notified of suspected anomalous traffic via email and the like. The user may also be solicited to review and approve a mitigation action before it is initiated, in order to continue an active mitigation action, and the like. In one example embodiment, the user may pre-authorize the mitigation of any and all anomalous network traffic, or may specify the instances where a mitigation action is pre-authorized. For example, the user may pre-authorize a mitigation action to address anomalous network traffic originating from a particular device or IP address.

As previously stated, DDoS attacks are by definition distributed, and therefore it can be very difficult to accurately detect and mitigate attack traffic when the attacking source IP addresses are so widespread. Furthermore, a growing trend among DDoS attackers is to utilize sophisticated spoofing techniques and essential protocols to make DDoS attacks even more stealthy and disruptive. These attacks, which use legitimate application protocols and services, are very difficult to identify and defeat.

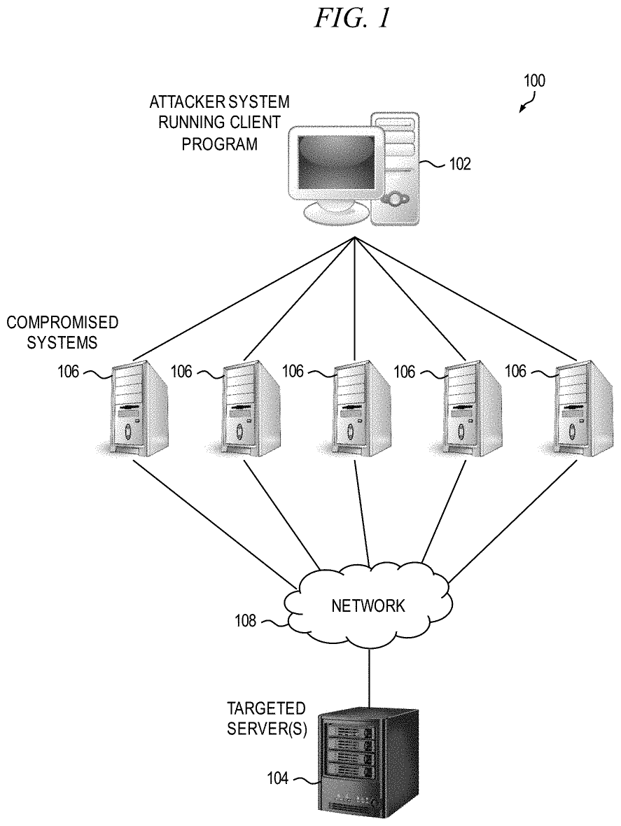

FIG. 1 is a block diagram conceptually depicting the occurrence of a DDoS attack in an example networked computing system 100. In a typical DDoS attack, an attacker system 102 running a client program seeks to make a targeted system 104, often one or more Web servers, unavailable to its intended users. Denial of service is typically accomplished by the attacker system 102 flooding the targeted system 104 with superfluous requests or other malicious traffic via multiple compromised computer systems 106 connected with the targeted system in a distributed manner through a network 108, such as the Internet. The incoming traffic flooding the targeted system 104 in a DDoS attack originates from many different sources (e.g., compromised systems 106), thereby making it effectively impossible to stop the attack simply by blocking a single source.

The terms “network traffic,” or “data traffic,” or simply “traffic” as used herein are intended to broadly refer to the amount of data moving across a network at a given point in time. From a computing standpoint, network data in computer networks is most typically encapsulated in data packets, which provide the load in the network.

Currently, detection of DDoS attacks is based on the volume of traffic and not the source of the traffic. For example, a standard DDoS detection scheme may involve inspecting the volume of data packets sent to a certain customer from all sources under “normal” conditions to establish a baseline traffic level, and if there is a large increase in the volume of traffic compared to the established baseline level, a DDoS attack is suspected. Various parameters may be used to determine whether a threshold level of traffic has been exceeded, such as, but not limited to, evaluating total User Datagram Protocol (UDP) traffic, total Domain Name System (DNS) traffic, various protocols commonly used for DDoS attacks, and the like.

When the volume of detected traffic exceeds some threshold, either a prescribed value or based on one or more algorithms or software, some action is taken which may be in the form of, for instance, triggering an alert or blocking what is believed to be the attacking traffic. Current DDoS attack mitigation may involve, for example, broad packet-filtering, throttling or rate-limiting the traffic to alleviate what is presumed to be a DDoS attack, when in reality the traffic may be attributable to valid users. Employing these measures, however, simply facilitates the attacker's desired objective by shutting down the system, causing denial of service to legitimate users.

Embodiments of the invention, according to aspects thereof, beneficially provide apparatus and/or methods for detecting and mitigating the threat of DDoS attacks by using, at least in part, a central controller. In one example embodiment, the central controller detects and mitigates attacks on hosts that are running a service that can be used by an attacker for DDoS amplification (such as DNS, NTP, Chargen, Memcache, and the like).

In one or more embodiments, the central controller obtains netflow records from network devices, such as routers. In one example embodiment, the central controller also obtains alerts, such as alerts from intrusion detection systems (IDS). Each IDS inspects the incoming network traffic and sends the alerts to the central controller. As described above, the netflow records and alert may contain only the source address of the network traffic (such as a source IP address), or may contain additional information. The IDS or router obtains the source address of the network traffic (which is typically the source IP address of the attack victim) and sends it to the central controller. The central controller monitors the alerts and/or netflow records, and makes a decision as to whether the traffic is part of an attack based on one or more detection rules. In one example embodiment, a particular pattern of network traffic, such as a continuous stream of DNS queries, is assumed to be an attack.

In response to a detection of an attack, the central controller extracts, for example, the IP address of the victim that is being targeted by the attack traffic and generates one or more mitigation rules to mitigate the attack. For example, a mitigation rule may indicate that the attack traffic should be blocked. The mitigation rules are then sent to and implemented by various network devices to implement the mitigation action (for example, to block the attack traffic). Once the central controller no longer detects the attack traffic, the central controller instructs the network devices to remove the mitigation action, such as to remove the block on the attack traffic.

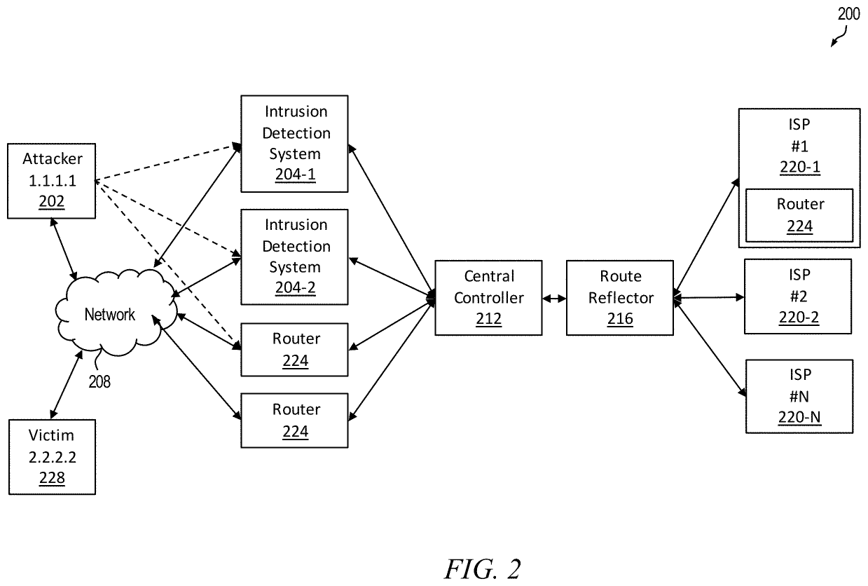

FIG. 2 is a block diagram depicting at least a portion of an exemplary system 200 for detecting and mitigating DDoS attacks in a networked computing system, according to an embodiment of the invention. As shown in FIG. 2, the DDoS detection and mitigation system 200 includes one or more intrusion detection systems 204-1, 204-2 (known collectively as intrusion detection systems 204 herein) operatively coupled with a network 208 (e.g., the Internet), one or more routers 224, a central controller 212 operatively coupled with the intrusion detection systems 204, the router 224, and a route reflector 216, and one or more sub-networks 220-1, 220-2, . . . 220-N (known collectively as sub-networks 220 herein) operatively coupled with the route reflector 216. In one example embodiment, the central controller 212 is integrated into one of the intrusion detection systems 204. “N” is generally used to signify an arbitrary number, and the number of interceptors can be the same or different than the number of sub-networks. Elements can be “operatively coupled,” for example, by wired and/or wireless networking and/or internetworking.

The sub-networks 220 may be, for example, the network of an internet service provider, a data center, and the like. Each sub-network 220 may comprise one or more routers 224 that are configured to receive requests or other traffic from the network with which the router is operatively coupled (e.g., in wired or wireless communication therewith). In one or more embodiments, the router is configured to characterize network operation by collecting IP network traffic flow information as the traffic enters or exits an interface or network node, such as, for example, using NetFlow (a product of Cisco Systems, Inc.) or the like. By analyzing the data provided by NetFlow, a network administrator can determine information relating to the operational status of the network, such as, but not limited to, the source and destination of traffic, class of service, and the causes of congestion. In order to characterize network operation, the router 224, in one or more embodiments, is configured to aggregate packets into flows and to export flow records, to receive, store and pre-process the flow records, and to analyze the received flow data in the context of intrusion detection and/or traffic profiling, for example. At least a subset of the network traffic flow information may be passed to the central controller 212 where the traffic flow may also be monitored for the presence of a possible DDoS attack condition.

As noted above, each IDS 204 also inspects the incoming network traffic and sends alerts, including any spoofed IP addresses, to the central controller 212. The central controller 212 analyzes the alerts from each IDS 204 and/or netflow records from the routers 224 using, for example, one or more detection rules and makes a decision as to whether the traffic is part of an attack. In one example embodiment, a particular pattern of traffic, such as a spike in traffic, a continuous stream of traffic (such as a continuous stream of DNS queries), and the like is assumed to be a malicious attack. If an attack is determined to be underway, the central controller 212 obtains the IP address of the victim that is being targeted by the attack traffic and generates one or more mitigation rules to mitigate the attack traffic. For example, a mitigation rule may specify that network traffic having a source address that matches the IP address of the victim be blocked. The mitigation rules are sent, for example, to the route reflector 216 which determines the network devices, such as routers 224 and the like, of the sub-networks 220 that will implement the mitigation rules. The route reflector 216 then forwards the mitigation rules to the identified network devices. In one example embodiment, the central controller 212 sends a message or other control signal to the network device instructing the network device to handle all traffic from a specified IP address differently from the normal IP traffic, including, but not limited to, blocking or discarding packets from the attack traffic (either randomly or in some defined manner), rate-limiting the traffic, diverting the traffic to a different path (e.g., by changing the target IP address) for performing deep packet inspection (DPI) or another analysis mechanism on all or a subset of the packets constituting the malicious traffic flow, and the like. In this manner, traffic originating from the flagged IP source is disrupted while traffic originating from trusted IP sources is allowed to pass, thereby eliminating the DDoS attack without impacting legitimate users.

Once the central controller 212 no longer detects the attack traffic, the central controller 212 instructs the network devices and/or host to remove the mitigation action, such as remove the block of the attack traffic.

In detecting the presence of a potential DDoS attack, the central controller 212, in one or more embodiments, is configured to monitor the volume of packets received from an attacker 202. As described above, a particular pattern of network traffic, for example, may be assumed to be an attack. In the former case, the central controller 212 may utilize one or more thresholds, which may be stored either internally or may reside externally to the central controller 212. The thresholds may be based on a prescribed value, on one or more algorithms or software (e.g., modeling a behavior and/or operational status of the network), or some combination thereof, according to one or more embodiments; the thresholds may be fixed or dynamic. Various parameters may be used to determine whether a threshold level of traffic has been exceeded, including, but not limited to, evaluating total UDP traffic, total DNS traffic, various protocols commonly used for DDoS attacks, and the like.

In one example embodiment, the decision of whether a submission is treated as an attack is based on a received traffic volume originating from a potentially malicious source (such as a spike in traffic volume) and prescribed threat information. The threat information preferably comprises a risk level or weighting of risk. This weighting is used to determine a probability that the incoming traffic is originating from a malicious IP source. In one or more embodiments, the threat information may be in the form of a whitelist of valid autonomous system numbers (ASNs), a blacklist of malicious ASNs, and the like. Preferably, the threat information is updated periodically, for example, automatically based on historical data or manually by a user, so that the threat information is kept current to adapt to changing threats. It is to be appreciated that embodiments of the invention are not limited to any specific form(s) of the threat information in evaluating whether the spike in traffic flow is attributable to a malicious IP source.

The network devices of the sub-networks 220 that implement the mitigation rules may be “peering” routers. In a typical scenario, the attack systems 202 operate in a distributed manner to flood (and thereby overwhelm) a targeted victim system 228 with superfluous requests or other malicious traffic through the network 208, such as the Internet. The superfluous traffic may be channeled through a router 224, which may be an Internet Service Provider (ISP) peering router or the like. The term “peering” as used herein is intended to refer broadly to an arrangement of traffic exchange between two or more ISPs; larger ISPs (e.g., the Internet) with their own backbone networks that agree to allow traffic from other large ISPs in exchange for traffic on their backbones. They also exchange traffic with smaller ISPs, such as, for example, an ISP network (such as sub-network 220), so that they can reach regional end points.

Peering typically requires the exchange and updating of router information between the peered ISPs, typically using Border Gateway Protocol (BGP) or another suitable communication protocol. Generally, peering parties interconnect at network focal points, such as, for example, network access points (NAPs) in the United States and at regional switching points. Each major ISP generally develops a peering policy that states the terms and conditions under which it will peer with other networks for various types of traffic.

As illustrated in FIG. 2, the peering router 224 is in operative communication with the ISP network (such as sub-network 220). The peering router 224, in one or more embodiments, is configured to control traffic between the Internet 208 and the ISP network (such as sub-network 220), generally via one or more BGP sessions (or suitable alternative communications protocols) established between the router 224 and the Internet 208 and/or ISP network (such as sub-network 220).

The peering router 224 is operatively coupled with the central controller 212; at least portions of the central controller 212, in one or more embodiments, are incorporated within at least one data center (e.g., a national data center (NDC) and/or a regional data center (RDC)) in communication with the peering router 224.

The peering router 224 may include a first mitigation device (not shown) which is adapted to receive the output message from the central controller 212 and to perform one or more actions in response thereto for mitigating a DDoS attack. The mitigation device may be a separate device or an application or module running on the peering router 224 itself. DDoS mitigation actions which may be performed by the mitigation device may include, but are not limited to, rate-limiting the traffic, discarding packets from the traffic (either randomly or in some defined manner), performing DPI on all or a subset of the packets constituting the malicious traffic flow, and the like.

Still referring to FIG. 2, the most common type of DDoS attack is where an attacker uses other computers/devices on the Internet to amplify the traffic. For example, the attacker 202 has true IP address 1.1.1.1 but spoofs the IP address 2.2.2.2 of the victim 228. The attack traffic will come into hosts that are vulnerable to amplification; e.g., open DNS servers on the Internet that have been incorrectly set up. A small DNS query may ask for all entries for google.com; the DNS server will then reply with a much larger response including search.google.com, mail.google.com, and so on. Multiple packets are then sent back to the victim 228 because the attacker 202 spoofed the source IP of the victim. The attacker picks out a DNS query which is a small query but results in a large reply with multiple packets, to amplify the attack. If the query is then sent to a large number of open DNS servers, a large number of packets will be directed back to the victim 228. In one or more embodiments, the intrusion detection system 204 determines the true victim IP address and type of attack and feeds this information to the central controller 212. Central controller 212 then creates a rule to block attack traffic to address 2.2.2.2; this is sent to the route reflector 216 which then sends the rules to all of the different routers 224 of the ISPs 220, which block the attack traffic directed to victim 228. In some cases, when continuous queries (e.g. thousands of requests per second to the same DNS server) are noted, it is assumed that there is an attack under way; an ordinary number of requests is not considered as suspicious. In a non-limiting example, the intrusion detection systems 204 are within the network of an ISP such as a broadband provider; the central controller 212 resides in a datacenter; the route reflector 216 resides in a data center or is connected to a backbone network; and the ISPs 220 are individual peering routers within the broadband provider's network and/or in the network(s) of other ISP(s). The skilled artisan will appreciate that peering routers provide connections to other ISPs/networks; for example, in a co-location facility. In one or more embodiments, the central controller 212 and/or intrusion detection systems 204 are employed to dynamically generate mitigations for the DDoS attack (e.g., actively block).

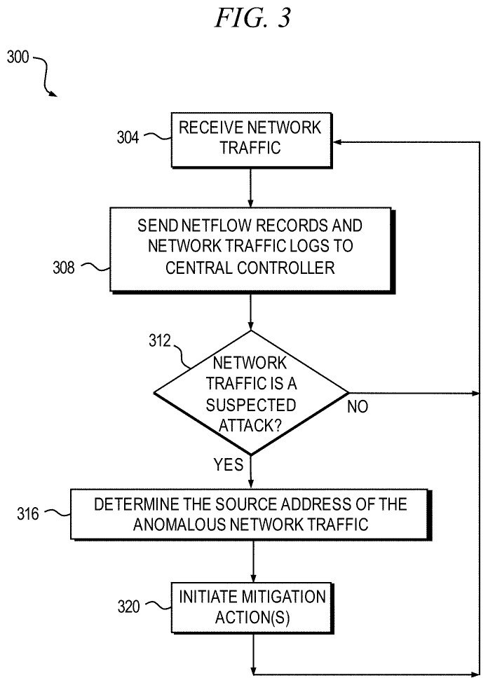

FIG. 3 is a flow diagram depicting a first example method 300 for detecting and mitigating DDoS attacks, according to an embodiment of the invention. In one example embodiment, at least a portion of the DDoS detection flow of the method 300 is implemented in the central controller 212. In one example embodiment, operations 312 through 320 are performed by the central controller 212.

With continued reference to FIG. 3, in accordance with the method 300, the router 224 and/or the intrusion detection system 204 receives network traffic from an attacker in step 304. In step 308, the netflow records and/or network traffic logs are sent to the central controller 212. The central controller 212 then determines whether the network traffic is part of a suspected attack in step 312. In one example embodiment, the central controller 212 determines that the network traffic is a suspected attack based on one or more detection rules. A rule may indicate that the network traffic is a suspected attack based a pattern of the network traffic, such as whether the network traffic exhibits a spike in volume, is a continuous stream, and the like.

In one example embodiment, the central controller 212 determines that the network traffic is a suspected attack if a rate of the network traffic exceeds a predefined threshold, such as an established baseline normal traffic level of, for example, 5 packets per second. This threshold information, or a portion thereof, may be obtained from a source external to the intrusion detection system 204 and central controller 212 (e.g., external database, software module running a dynamic threshold calculation application, and the like) or at least a portion of the threshold information may be stored within the central controller 212 (e.g., historical baseline normal traffic level). The volume of traffic received by the intrusion detection system 204 and/or router 224 may be compared with threshold information (e.g., using a comparator or other comparison mechanism) to determine whether or not the volume of traffic flow exceeds the defined threshold. When the volume of traffic does not exceed the level defined by the threshold information and the network traffic does not otherwise satisfy a rule indicating that an attack is underway, the central controller 212 determines that the network traffic is not a suspected attack and the method 300 continues with step 304 (NO branch of decision block 312). When the volume of traffic exceeds the level defined by the threshold information or the network traffic otherwise satisfies a rule indicating that an attack is underway, the central controller 212 determines that the network traffic is a suspected attack and the method 300 proceeds with step 316 (YES branch of decision block 312). Given the teachings herein, the skilled artisan will be able to select a suitable threshold based on the application. It is worth noting that it is typically not necessary for the packet to be sent to a DPI device if the central controller cannot make a determination; however, this can be done in some instances. Furthermore, in some cases, a sample of packets can be sent to the DPI device instead of all packets.

In step 316, the source address of the anomalous network traffic is determined. In step 320, the central controller 212 initiates one or more attack mitigation actions. Such actions may comprise, for example, rate-limiting the traffic from the flagged source address, discarding packets from the flagged source address, diverting traffic flow to a specified network address, performing DPI on the traffic flow, and the like, as previously described. For example, the central controller 212 may send a message or other control signal to a host and/or network device of a sub-network 220 instructing the network device to handle all traffic from a specified network address differently from the normal network traffic. Prescribed mitigation actions may be stored in a database, table, whitelist, and the like. In this manner, the mitigation action performed can be tailored to the corresponding source address.

In one example embodiment, the central controller 212 detects a cessation of the malicious attack and directs that appropriate network devices to undo the mitigation action(s), such as to remove the block of the attack network traffic.

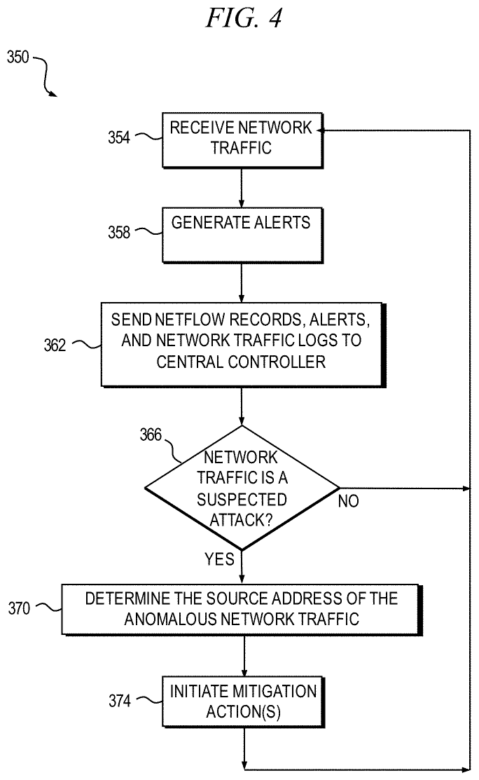

FIG. 4 is a flow diagram depicting a second example method 350 for detecting and mitigating DDoS attacks, according to an embodiment of the invention. In one example embodiment, at least a portion of the DDoS detection flow of the method 350 is implemented in the central controller 212. In one example embodiment, operations 366 through 374 are performed by the central controller 212. It is worth noting that, since the centralized controller 212 obtains input from all the different intrusion detection systems 204 in one or more embodiments, the centralized controller 212 has more information on which to base a determination of whether a putative attack is an actual attack, and then to generate a rule to block the attack traffic.

With continued reference to FIG. 4, in accordance with the method 350, the routers 224 and/or intrusion detection systems 204 receive network traffic from a suspected attacker in step 354. In step 358, the intrusion detection system 204 determines whether the network traffic is a suspected attack based on whether one or more detection rules are satisfied and generates an alert, if necessary. In one example embodiment, the intrusion detection system 204 determines that any network traffic for one or more particular network addresses received by the intrusion detection system 204 is a suspected attack. In one example embodiment, a detection rule indicates that the network traffic is a suspected attack based a pattern of the network traffic, such as whether the network traffic exhibits a spike in volume, is a continuous stream, and the like.

In one example embodiment, the intrusion detection system 204 determines that the network traffic is part of a suspected attack if a rate of the IP traffic exceeds a predefined threshold, such as an established baseline normal traffic level of, for example, 5 packets per second. As described above, this threshold information, or a portion thereof, may be obtained from a source external to the intrusion detection system 204 (e.g., external database, software module running a dynamic threshold calculation application, etc.) or at least a portion of the threshold information may be stored within the intrusion detection system 204 itself (e.g., historical baseline normal traffic level). In the latter case, the volume of traffic received by the intrusion detection system 204 is compared with threshold information (e.g., using a comparator or other comparison mechanism) to determine whether or not the volume of traffic flow exceeds the defined threshold. When the volume of traffic does not exceed the level defined by the threshold information and the network traffic does not otherwise satisfy a detection rule indicating that an attack is underway, the intrusion detection system 204 determines that the network traffic is not a suspected attack and no alert is sent. When the volume of traffic exceeds the level defined by the threshold information or the network traffic otherwise satisfies a detection rule indicating that an attack is underway, the intrusion detection system 204 determines that the network traffic is a suspected attack and an alert is generated. In step 362, the netflow records, alerts, and/or network traffic logs are sent to the central controller 212.

In decision block 366, the central controller 212 determines whether the network traffic is a suspected attack. If the network traffic is not a suspected attack, the method 300 continues with step 354 (NO branch of decision block 366). If the network traffic is a suspected attack, the method 300 continues with step 370 (YES branch of decision block 366).

In step 370, the source address of the anomalous network traffic is determined. In step 374, the central controller 212 initiates one or more mitigation actions. Such actions may comprise, for example, rate-limiting the traffic from the flagged source network address, discarding packets from the flagged source network address, diverting traffic flow to a specified network address, performing DPI on the traffic flow, and the like, as previously described. For example, the central controller 212 may send a message or other control signal to a network device of a sub-network 220 instructing the network device to handle all traffic from a specified network address differently from the normal network traffic. Prescribed mitigation actions may be stored in a database, table, whitelist, and the like.

In one example embodiment, the central controller, in cooperation with the intrusion detection system 204, detects a cessation of the malicious attack and directs that appropriate network devices to undo the mitigation action(s), such as remove the block of the attack network traffic.

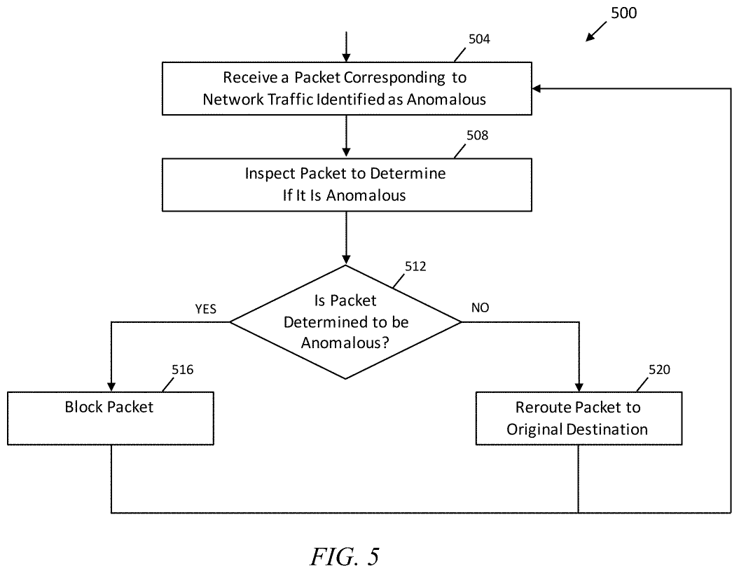

FIG. 5 is a flowchart of an example method 500 for performing a deep inspection of a suspected anomalous packet, in accordance with an example embodiment. In one example embodiment, a packet identified as anomalous is received by a deep packet inspection device residing, for example, in the ISP cloud (operation 504). The packet is inspected to determine if it is or is not anomalous (operation 508). For example, as described above, indicators of compromise in the traffic may be searched for, such as a destination IP address, a source or destination port, a protocol, a type, size, or contents of the payload, identification of a pattern in the traffic, a match of the pattern with known threat signatures, and the like. If the packet is determined to be anomalous (YES branch of decision block 512), the deep packet inspection device blocks the packet and/or sends an alert to the central controller 212 (operation 516), and the method 500 proceeds with operation 504; otherwise (NO branch of block 512), the packet is rerouted, for example, to its original destination (operation 520) and the method 500 proceeds with operation 504. In one example embodiment, the deep packet inspection device forwards information regarding the deep packet inspection to the central controller 212 for updating the classification rules.

Recapitulation

In one aspect, an exemplary method 300 includes operations of receiving one or more netflow records from one or more network devices 308, 362; identifying anomalous network traffic 312, 366; determining a source address of the anomalous network traffic 316, 370; and initiating a mitigation action based on the source address and one or more mitigation rules 320, 374, wherein a determination of whether the received data packet is part of a DDoS attack is based on one or more detection rules.

In one example embodiment, the identification of the anomalous network traffic further comprises identifying a UDP reflection DDoS attack and the mitigation action mitigates the UDP reflection DDoS attacks. In one example embodiment, at least one of the one or more detection rules indicates that any data packet that satisfies a specified data pattern is part of the DDoS attack. In one example embodiment, at least one of the one or more detection rules indicates that any data packet that is a part of network traffic having a volume that exceeds a specified threshold rate is part of the DDoS attack. In one example embodiment, at least one of the one or more mitigation rules indicates that network traffic from the determined source address is to be rate limited. In one example embodiment, at least one of the one or more mitigation rules indicates that network traffic from the determined source address is to be blocked, discarded, or both. In one example embodiment, at least one of the one or more mitigation rules indicates that network traffic from the determined source address is to be diverted to a specified network address. In one example embodiment, at least one of the one or more mitigation rules indicates that deep packet inspection (DPI) is to be performed on the network traffic from the determined source address.

In one example embodiment, at least one of the mitigation rules is sent to at least one of the one or more network devices 412. In one example embodiment, the at least one network device 412 is part of an internet service provider's infrastructure, a hosting provider's infrastructure, or an enterprise's infrastructure. In one example embodiment, a cancellation of the mitigation action is initiated in response to a cessation of the DDoS attack. In one example embodiment, an alert is received from an intrusion detection system 204, the alert comprising application layer information from a payload of the data packet indicating a type of query that is being requested. In one example embodiment, address information is obtained from a third-party threat intelligence provider, the address information corresponding to network traffic that has been identified as malicious network traffic; network traffic originating on a networked device is inspected in search of packets that correspond to the obtained address information 508; a check is performed to determine if a given one of the searched packets corresponds to an address associated with the address information 508; and, responsive to the check indicating that the given one of the searched packets corresponds to the address associated with the address information, a network device 412 is configured to mitigate the malicious network traffic 516.

In one example embodiment, the threat information comprises one or more of an address, a source or destination port, a protocol, a payload type, a payload size, contents of a payload, identification of a network traffic pattern, a match of the network traffic pattern with known threat signatures, headers or header metadata, a protocol type, a file analysis, frequency of beaconing, and a hash value. In one example embodiment, the threat information is a blacklist of IP addresses known or suspected to correspond to malicious network traffic. In one example embodiment, the threat information and a white list are compared, and addresses that are on the white list are removed from the threat information. In one example embodiment, at least one of the one or more network devices is configured to block or reroute the given one of the searched packets corresponding to the address associated with the address information. In one example embodiment, a user is solicited to review and approve the mitigation action before the mitigation action is initiated.

In one aspect, a system 200 for mitigating a distributed denial-of-service (DDoS) attack in a networked computing system comprises one or more network devices, each network device configured to provide netflow records; and at least one central controller configured to receive one or more of netflow records from the one or more network devices 308, 362, identify anomalous network traffic 312, 366, determine a source address of the anomalous network traffic 316, 370, and initiate a mitigation action based on the source address and one or more mitigation rules 320, 374, wherein a determination of whether the received data packet is part of the DDoS attack is based on one or more detection rules. In one example embodiment, the system further comprises an intrusion detection system 204 for generating an alert 358, and the central controller 212 is configured to receive the alert 362 and to use the alert to determine whether the received data packet is part of the DDoS attack 366.

In one aspect, a central controller 212 for mitigating a distributed denial-of-service (DDoS) attack in a networked computing system comprises a memory; and at least one processor, coupled to said memory, and operative to perform operations comprising receiving one or more netflow records from one or more network devices 308, 362; identifying anomalous network traffic 312, 366; determining a source address of the anomalous network traffic 316, 370; and initiating a mitigation action based on the source address and one or more mitigation rules 320, 374, wherein a determination of whether the received data packet is part of the DDoS attack is based on one or more detection rules.

### System and Article of Manufacture Details

The invention can employ hardware aspects or a combination of hardware and software aspects. Software includes but is not limited to firmware, resident software, microcode, etc. One or more embodiments of the invention or elements thereof can be implemented in the form of an article of manufacture including a machine readable medium that contains one or more programs which when executed implement such step(s); that is to say, a computer program product including a tangible computer readable recordable storage medium (or multiple such media) with computer usable program code configured to implement the method steps indicated, when run on one or more processors. Furthermore, one or more embodiments of the invention or elements thereof can be implemented in the form of an apparatus including a memory and at least one processor that is coupled to the memory and operative to perform, or facilitate performance of, exemplary method steps.

Yet further, in another aspect, one or more embodiments of the invention or elements thereof can be implemented in the form of means for carrying out one or more of the method steps described herein; the means can include (i) specialized hardware module(s), (ii) software module(s) executing on one or more general purpose or specialized hardware processors, or (iii) a combination of (i) and (ii); any of (i)-(iii) implement the specific techniques set forth herein, and the software modules are stored in a tangible computer-readable recordable storage medium (or multiple such media). Appropriate interconnections via bus, network, and the like can also be included.

As is known in the art, part or all of one or more aspects of the methods and apparatus discussed herein may be distributed as an article of manufacture that itself includes a tangible computer readable recordable storage medium having computer readable code means embodied thereon. The computer readable program code means is operable, in conjunction with a computer system, to carry out all or some of the steps to perform the methods or create the apparatuses discussed herein. A computer readable medium may, in general, be a recordable medium (e.g., floppy disks, hard drives, compact disks, EEPROMs, or memory cards) or may be a transmission medium (e.g., a network including fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk. The medium can be distributed on multiple physical devices (or over multiple networks). As used herein, a tangible computer-readable recordable storage medium is defined to encompass a recordable medium, examples of which are set forth above, but is defined not to encompass transmission media per se or disembodied signals per se. Appropriate interconnections via bus, network, and the like can also be included.

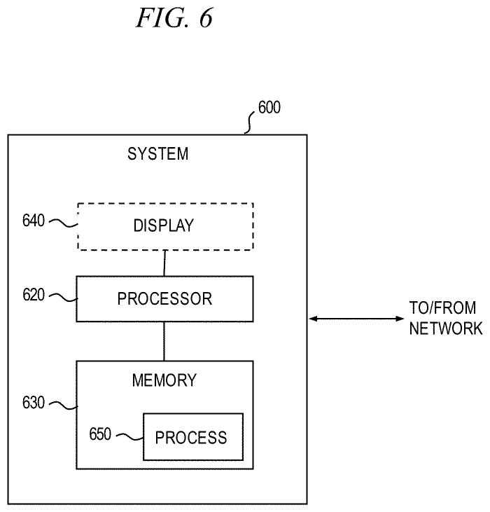

FIG. 6 is a block diagram of at least a portion of an exemplary system 600 that can be configured to implement at least some aspects of the invention, and is representative, for example, of one or more of the apparatus or modules shown in the figures. As shown in FIG. 6, memory 630 configures the processor 620 to implement one or more methods, steps, and functions (collectively, shown as process 650 in FIG. 6). The memory 630 could be distributed or local and the processor 620 could be distributed or singular. Different steps could be carried out by different processors, either concurrently (i.e., in parallel) or sequentially (i.e., in series).

The memory 630 could be implemented as an electrical, magnetic or optical memory, or any combination of these or other types of storage devices. It should be noted that if distributed processors are employed, each distributed processor that makes up processor 620 generally contains its own addressable memory space. It should also be noted that some or all of computer system 600 can be incorporated into an application-specific or general-use integrated circuit. For example, one or more method steps could be implemented in hardware in an ASIC rather than using firmware. Display 640 is representative of a variety of possible input/output devices (e.g., keyboards, mice, and the like). Every processor may not have a display, keyboard, mouse or the like associated with it.

The computer systems and servers and other pertinent elements described herein each typically contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

Accordingly, it will be appreciated that one or more embodiments of the present invention can include a computer program comprising computer program code means adapted to perform one or all of the steps of any methods or claims set forth herein when such program is run, and that such program may be embodied on a tangible computer readable recordable storage medium. As used herein, including the claims, unless it is unambiguously apparent from the context that only server software is being referred to, a “server” includes a physical data processing system running a server program. It will be understood that such a physical server may or may not include a display, keyboard, or other input/output components. Furthermore, as used herein, including the claims, a “router” includes a networking device with both software and hardware tailored to the tasks of routing and forwarding information. Note that servers and routers can be virtualized instead of being physical devices (although there is still underlying hardware in the case of virtualization).

Furthermore, it should be noted that any of the methods described herein can include an additional step of providing a system comprising distinct software modules or components embodied on one or more tangible computer readable storage media. All the modules (or any subset thereof) can be on the same medium, or each can be on a different medium, for example. The modules can include any or all of the components shown in the figures. The method steps can then be carried out using the distinct software modules of the system, as described above, executing on one or more hardware processors. Further, a computer program product can include a tangible computer-readable recordable storage medium with code adapted to be executed to carry out one or more method steps described herein, including the provision of the system with the distinct software modules.

Accordingly, it will be appreciated that one or more embodiments of the invention can include a computer program including computer program code means adapted to perform one or all of the steps of any methods or claims set forth herein when such program is implemented on a processor, and that such program may be embodied on a tangible computer readable recordable storage medium. Further, one or more embodiments of the present invention can include a processor including code adapted to cause the processor to carry out one or more steps of methods or claims set forth herein, together with one or more apparatus elements or features as depicted and described herein.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. A system for mitigating a distributed denial-of-service (DDoS) attack in a networked computing system, the system comprising:
one or more network devices, each network device configured to provide records including meta-data about network traffic; and
at least one central controller configured to receive one or more of the records including meta-data about network traffic from the one or more network devices, identify anomalous network traffic, determine a source address of the anomalous network traffic, and initiate a mitigation action based on the source address and one or more mitigation rules, wherein a determination of whether the received data packet is part of the DDoS attack is based on one or more detection rules.

2. The system of claim 1, further comprising an intrusion detection system for generating an alert, and wherein the central controller is configured to receive the alert and to use the alert to determine whether the received data packet is part of the DDoS attack.

3. The system of claim 1, wherein the identification of the anomalous network traffic further comprises identifying a UDP reflection DDoS attack and wherein the mitigation action mitigates the UDP reflection DDoS attacks.

4. A method for mitigating a distributed denial-of-service (DDoS) attack in a networked computing system, the method comprising:
receiving one or more records including meta-data about network traffic from one or more network devices;
identifying anomalous network traffic;
determining a source address of the anomalous network traffic; and
initiating a mitigation action based on the source address and one or more mitigation rules, wherein a determination of whether the received data packet is part of the DDoS attack is based on one or more detection rules.

5. The method of claim 4, wherein one of the one or more detection rules indicates that any data packet that satisfies a specified data pattern is part of the DDoS attack.

6. The method of claim 4, wherein at least one of the one or more detection rules indicates that any data packet that is a part of network traffic having a volume that exceeds a specified threshold rate is part of the DDoS attack.

7. The method of claim 4, wherein at least one of the one or more mitigation rules indicates that network traffic from the determined source address is to be rate limited.

8. The method of claim 4, wherein at least one of the one or more mitigation rules indicates that network traffic from the determined source address is to be blocked, discarded, or both.

9. The method of claim 4, wherein at least one of the one or more mitigation rules indicates that network traffic from the determined source address is to be diverted to a specified network address.

10. The method of claim 4, wherein at least one of the one or more mitigation rules indicates that deep packet inspection (DPI) is to be performed on the network traffic from the determined source address.

11. The method of claim 4, further comprising sending at least one of the mitigation rules to at least one of the one or more network devices.

12. The method of claim 11, wherein the at least one network device is part of an internet service provider's infrastructure, a hosting provider's infrastructure, or an enterprise's infrastructure.

13. The method of claim 4, further comprising initiating a cancellation of the mitigation action in response to a cessation of the DDoS attack.

14. The method of claim 4, further comprising receiving an alert from an intrusion detection system, the alert comprising application layer information from a payload of the data packet indicating a type of query that is being requested.

15. The method of claim 4, further comprising performing operations comprising:
obtaining address information from a third-party threat intelligence provider, the address information corresponding to network traffic that has been identified as malicious network traffic;
inspecting network traffic originating on a networked device in search of packets that correspond to the obtained address information;
performing a check to determine if a given one of the searched packets corresponds to an address associated with the address information; and
responsive to the check indicating that the given one of the searched packets corresponds to the address associated with the address information, configuring a network device to mitigate the malicious network traffic.

16. The method of claim 15, wherein the threat information comprises one or more of an address, a source or destination port, a protocol, a payload type, a payload size, contents of a payload, identification of a network traffic pattern, a match of the network traffic pattern with known threat signatures, headers or header metadata, a protocol type, a file analysis, frequency of beaconing, and a hash value.

17. The method of claim 15, wherein the threat information is a blacklist of IP addresses known or suspected to correspond to malicious network traffic.

18. The method of claim 15, further comprising comparing the threat information and a white list, and removing addresses that are on the white list from the threat information.

19. The method of claim 15, wherein at least one of the one or more network devices is configured to block or reroute the given one of the searched packets corresponding to the address associated with the address information.

20. The method of claim 15, further comprising soliciting a user to review and approve the mitigation action before the mitigation action is initiated.

21. The method of claim 4, wherein the identifying the anomalous network traffic further comprises identifying a UDP reflection DDoS attack and wherein the mitigation action mitigates the UDP reflection DDoS attacks.

22. A central controller for mitigating a distributed denial-of-service (DDoS) attack in a networked computing system, the central controller comprising:
a memory; and
at least one processor, coupled to said memory, and operative to perform operations comprising:
receiving one or more records including meta-data about network traffic from one or more network devices;
identifying anomalous network traffic;
determining a source address of the anomalous network traffic; and
initiating a mitigation action based on the source address and one or more mitigation rules, wherein a determination of whether the received data packet is part of the DDoS attack is based on one or more detection rules.

23. The central controller of claim 22, wherein the identification of the anomalous network traffic further comprises identifying a UDP reflection DDoS attack and wherein the mitigation action to be initiated comprises mitigating the UDP reflection DDoS attacks.
